(19) United States
(12) Patent Application Publication
(10) Pub. No.: US 2006/0249879 A1
(43) Pub. Date: Nov. 9, 2006

(54) Method for manufacturing visual communication panels and device used thereby

(76) Inventor: Leo Gypen, Zonhoven (BE)

Correspondence Address: BACON & THOMAS, PLLC, 625 SLATERS LANE, FOURTH FLOOR, ALEXANDRIA, VA, 22314, US

(21) Appl. No.: 10/554,200

(22) PCT Filed: Apr. 1, 2004
(86) PCT No.: PCT/BE04/00047

§ 371 Date: Oct. 24, 2005

(30) Foreign Application Priority Data
Apr. 28, 2003 (BE) 2003/0263

(51) Int. Cl. B29C 41/02

(52) U.S. Cl. 264/259

(57) ABSTRACT

Method for manufacturing visual communication panels including a support (2), provided on at least one side with a coating (11) made of enamelled metal, glazed at temperatures above 500° C., involves applying a continuous coating layer (11) of enamelled metal on at least one side of a continuous support (2) in the form of a plate; applying a layer of glue (26) between the support (2) and a coating layer (11); pressing the coating layer (11) against the support (2) to form a continuous panel with the required thickness; and finally, if necessary, sawing the obtained continuous panel into individual panels (25) with the required dimensions.

The present invention concerns a method for manufacturing visual communication panels.

The invention also concerns a device for manufacturing such visual communication panels.

In particular, the invention concerns a method for manufacturing visual communication panels of the type which mainly consists of a support or core which is provided at least on the reveal of the presentation panel with a coating in the shape of a layer of enamelled metal, in particular a thin metal layer which is provided on minimally one side with minimally one cover layer of enamel or glaze.

Usually, with such known visual communication panels, also the back side is provided with a coating, either or not of a different nature than the coating on the reveal, which is to prevent any warping of the panel.

Such visual communication panels can be used, depending on the nature and properties of the enamel cover layer, as a board that can be written on with felt-tip pens or chalk, as a projection screen for slide or film shows, as an interactive communication panel for video conferences or the like, whereby the movements of a pen or a virtual pen on the panel are digitally registered and are represented “on line” on a viewing screen, for example on the other side of the conferencing line or the like.

As is known, such visual communication panels have been manufactured according to a discontinuous method until now, whereby these panels are made one piece after the other on the basis of a support in the form of a plate with finite dimensions, and of one or two pieces of coating with corresponding dimensions provided on the support in the form of a plate, and fixed onto it by means of gluing or the like.

A disadvantage of such a known discontinuous production method is that it allows only for a restricted production rate, in that it is very labour-intensive and implies high production costs.

The present invention aims to remedy these and other disadvantages in that it provides for a method which makes it possible to manufacture visual communication panels in a continuous production line, whereby a continuous panel is obtained consisting of a support provided on at least one side with a coating of enamelled metal as mentioned above and whereby individual visual communication panels with the required dimensions can be made from said continuous panel by means of sawing or the like.

To this end, the invention concerns a method for manufacturing visual communication panels which mainly consists in applying a continuous coating layer of enamelled metal on at least one side of a continuous support in the form of a plate; in applying a layer of glue between the support and a coating layer; in pressing the coating layer on the support in order to form a continuous panel with the required thickness; and finally, if necessary, in sawing the obtained continuous panel into individual panels with the required dimensions.

The continuous support is preferably provided on both sides with a continuous coating layer of which at least one coating layer is formed of enamelled metal.

An advantage of the method according to the invention is that, since a continuous support and a continuous coating layer or layers are taken as a basis, it becomes possible to manufacture visual communication panels according to a continuous labour-saving production process, characterised by a relatively high production rate and relatively low production costs.

Preferably, in order to press on the coating layer or layers, the above-mentioned support is synchronously led through a laminating device together with the coating layer or layers, whereby the continuous coating layer or layers are each unwound from a roll and are preferably heated so as to obtain, improve or accelerate the gluing.

The above-mentioned layer of glue can be formed of a cold glue or a hot glue whereby, in the latter case, the layer of glue is first melted by heating in the laminating device, after which the layer of glue is congealed again by cooling it down in order to provide for a bond between the support and the coating layer or layers.

The above-mentioned layer of glue can be formed of a heat-activated adhesion film, whereby this dry adhesive film becomes sticky or liquid under the influence of the temperature and/or under the influence of temperature and pressure.

The above-mentioned layer of glue can also be formed of various types of cold glue, what are called contact adhesives, which provide for a bond thanks to the evaporation of organic solvents; of a water-based adhesive dispersion, such as for example polyvinyl acetate glue, which provides for a bond thanks to the evaporation of water; of a single-part or two-part liquid polyurethane adhesive or of an epoxy adhesive which provides for a bond as the liquid glue cures.

The layer of glue can also be formed of various types of hot glues, what are called hot-melt adhesives, which provide for a bond as the melted glue congeals; of a polyurethane hot glue which provides for a bond as the melted glue congeals and cures; of industrially available reactive hot adhesive granules or powders, such as for example ethylene acrylic co-polymers, which provide for a bond by means of temperature and pressure, whereby these hot adhesive granules can be integrated, however, in an extruded thermoplastic synthetic foil.

The above-mentioned layer of glue can for example be applied by means of spraying, curtain coating, roller coating, silkscreen printing, stencilling, powdering or scattering, by means of extrusion or co-extrusion, or it can also be applied in the shape of an adhesive film which is unwound from a roller and which is led through the above-mentioned laminating device together with the support and the coating layer or layers concerned.

The invention also concerns a device for manufacturing visual communication panels according to the above-described method, whereby this device mainly consists of a transport table for a continuous support; at least one roll of a continuous coating layer formed of a continuous layer of enamelled metal; a laminating device through which the above-mentioned support and the coating layer are led; means to apply a layer of glue between the support and the coating layer; and possibly a sawing device, downstream of the laminating device.

In order to better explain the characteristics of the invention, the following preferred embodiments of a device according to the invention for manufacturing visual communication panels are described as an example only without being limitative in any way, with reference to the accompanying drawings, in which:

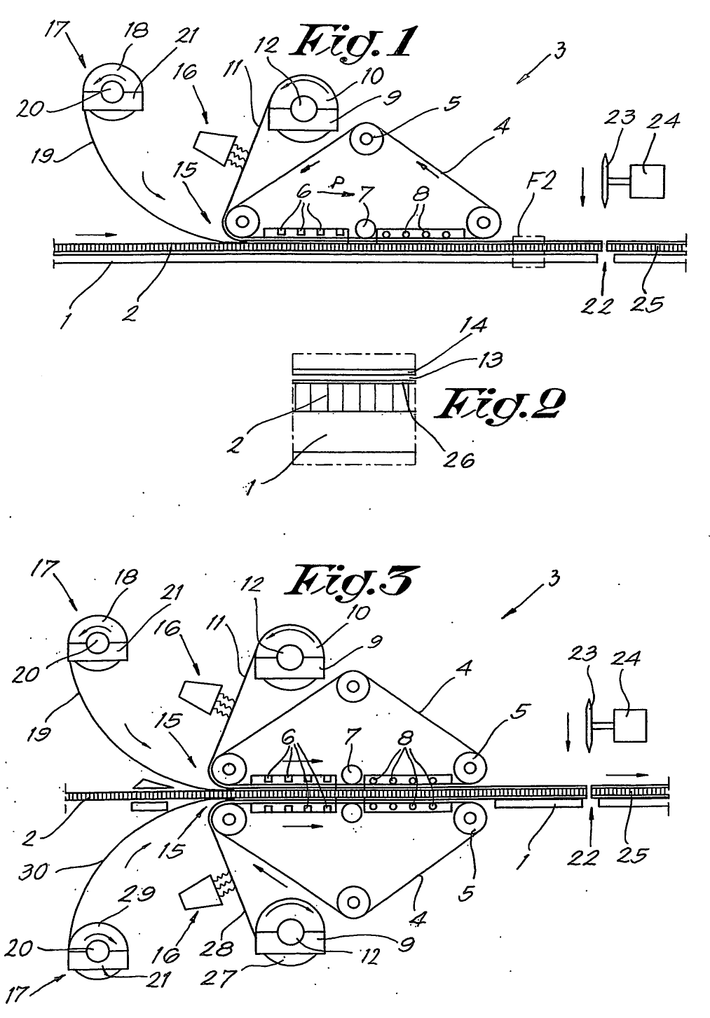

FIG. 1 schematically represents a device according to the invention;

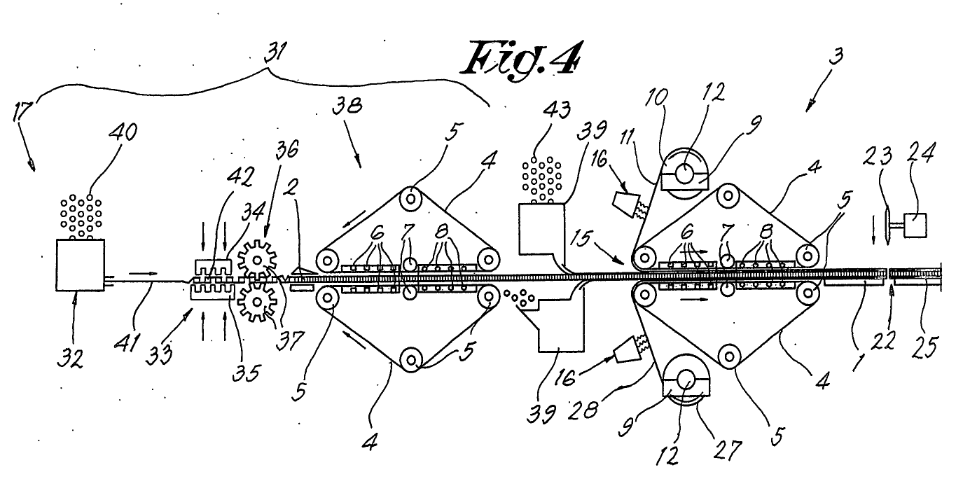

FIG. 2 represents the part indicated by F2 in FIG. 1 to a larger scale;

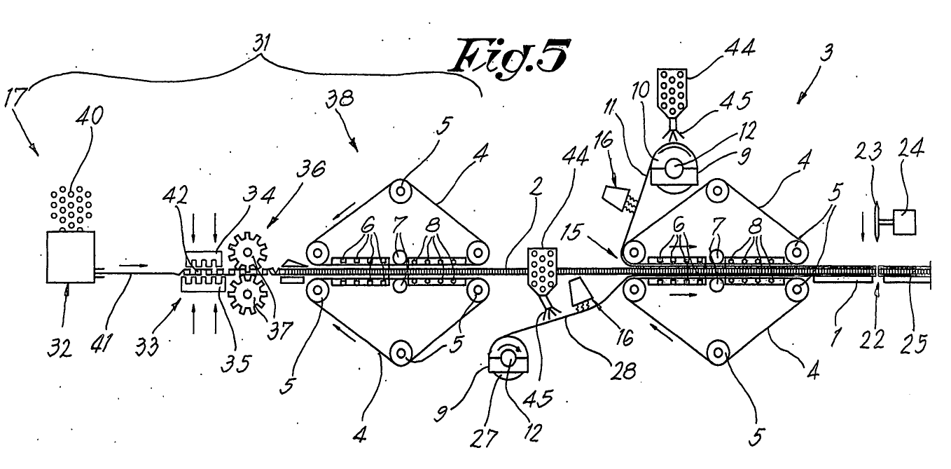

FIG. 3 represents a variant of the device according to FIG. 1;

FIGS. 4 to 7 represent variants of a device according to FIG. 3 to a smaller scale.

The device of FIG. 1 mainly consists of a transport table 1 for a continuous support 2 in the form of a plate and, at a short distance from said table 1, a laminating device 3 extending over the width of the table and which in this case consists of an endless belt 4 led over three rollers 5, two rollers 5 of which are situated at a certain distance from the table 1, such that the endless belt 4 is parallel to the surface of the table 1 with one part.

The laminating device 3 is equipped with a drive, not represented in the figures, for example in the shape of a motor which is directly or indirectly coupled to one or several of the above-mentioned rollers 5.

On the inner side of the conveyor belt 4, opposite to the top of the table 1, are provided one or several heating elements 6, one or several press-on rollers 7 and one or several cooling elements 8.

On either side of the table 1 are provided two bearing cushions 9, opposite to one another, in which is suspended a roll 10 of a coating layer 11 of enamelled metal by means of a shaft 12 that can be freely rotated, whereby the roll 10 is situated above the table 1 and has a width which is equal or almost equal to that of the support 2.

As is represented in greater detail in FIG. 2, the coating layer 11 of enamelled metal is formed of one or several thin metal layers 13 upon which may be applied an enamelled first adhesive layer, but at least an enamelled cover layer 14 which, as is known, is obtained by melting a layer of enamel provided on the metal layer 13 as a liquid dispersion or in a powdered form, which is heated to a temperature above 500° C.

Depending on the required type of application, coating layers 11 can be applied with an adapted enamel cover layer. Thus, coating layers are known which can be written on with felt-tip pens or which have the characteristics of a chalk board or which, by adding special pigments to the enamel, are suitable as a base for projections or the like.

In between the above-mentioned roll 10 and the inlet 15 of the laminating device 3 are provided means 16 to heat the coating layer 11, whereby these means 16 consist for example of infrared radiators or the like which are directed onto the coating layer 11.

Upstream of the laminating device 3 are provided means 17 which make it possible to provide a layer of glue between the above-mentioned support 2 and the coating layer 11, whereby these means 17 in this case consist of a roll 18 of adhesive film 19 provided at a distance above the table 1 on a shaft 20 which is suspended in a freely rotating manner in bearings 21, whereby this roll 18 extends in the width of the table 1 and whereby the adhesive film 19 has the same, or practically the same width as the coating layer 11.

As an adhesive film 19 can for example be applied a double-sided adhesive tape or, as in the given example, a film made of a hot glue which melts when heated and which cures again when cooled to a normal ambient temperature, or a temperature-activated adhesive film which gets sticky or melts when being heated and possibly when being pressed on, and which will subsequently adhere while being cooled.

Downstream of the laminating device, opposite to an opening 22 in the table 1, is erected a sawing device which is represented by a saw blade 23 and a driving motor 24 in the figures, whereby this saw blade 23 and the motor 24 can preferably be moved at least in the cross direction of the table 1.

The working and use of the device according to the invention is very simple and as follows.

In order to form visual communication panels 25, a continuous support 2 in the form of a plate is fed onto the table 1 and this support 2, together with the coating layer 11 and the adhesive film 19, is led between the table 1 and the endless belt 4 of the laminating device 3 at the inlet 15 of the laminating device 3.

By driving the endless belt 4 in the direction of arrow P in FIG. 1, the support 2, the coating layer 11 and the adhesive film 19 are moved together in a synchronous manner through the laminating device, whereby both the coating layer 11 and the adhesive film 19 are unwound from their respective rolls 10 and 18.

During this passage, the adhesive film 19 is activated by the heat of the heating elements 6 and thus is obtained a gluing 26 between the support 2 and the coating layer 11, after which the support 2 and the coating layer 11 are pressed together by the press-on rollers 7 to the required thickness of the ultimate visual communication panels 25, after which, thanks to the cooling elements 8, the layer of glue 26 cools again and forms a strong bond between the support 2 and the coating layer 11 of enamelled metal, such that, at the exit of the laminating device 3, a continuous panel is formed of which can be sawn pieces having the required dimensions to form the required visual communication panels 25

Thanks to the infrared radiators 16, the coating layer 11 is heated when entering the laminating device 2, as a result of which the coating layer 11 in the laminating device 3 has to be heated less abruptly or not at all to activate the adhesive film 19.

It is clear that the production takes place according to a continuous process. The continuously formed panels are sawn transversally, while the saw 23 runs longitudinally along with the belt without the production having to be interrupted for sawing off the required visual communication panels 25.

Naturally, the production rate is much faster in this case than when such visual communication panels 25 have to be made piece by piece in the known manner.

FIG. 3 represents a variant of the device according to FIG. 1 whereby, at the height of an interruption in the table 1, a laminating device 3 is provided, in this case with two endless belts 4, provided opposite to one another, above and under the surface of the table 1 respectively.

A roll 27 with a second coating layer 28 and a roll 29 with a second adhesive film 30 are provided under the table 1.

In this case, thanks to a synchronous movement of the two belts 4, the support 2 is moved through the laminating device 3 together with the two coating layers 11-28 and the two adhesive films 19-30, so that, in the same manner as described above, the coating layers 11-28 are glued on the support 2, so that, at the exit of the laminating device 3, is created a continuous sandwich panel whose presentation panels 25 can be sawn to the required dimensions.

The second coating layer 28 for coating the back side of the visual communication panels 25 may be a coating layer of enamelled metal, but it can also be formed of other materials, such as galvanised steel, aluminised steel, lacquered steel, aluminium, melamine or other synthetic materials, foil reinforced with glass fibre, paper, cardboard, cork or the like.

If necessary, the laminating device 3 can be replaced by a rolling device with rolls which may be either or not heated.

FIG. 4 represents a variant of FIG. 3, whereby a production line 31 for manufacturing a continuous support 2 with a honeycomb structure of synthetic material is in this case erected upstream of the laminating device.

The production line 31 in this case consists for example of a device as described in WO 00/32382, which is mainly formed of an extruder press 32, followed by a moulding press 33 with an upper mould 34 and a lower mould 35, a folding installation 36 with two gear wheels 37 and an additional laminating device 38 which is analogous to the above-described laminating device 3 with double belts.

The above-mentioned means 17 for applying a layer of glue 26 between the support 2 and the coating layers 11-28 in this case consist of two extruding applications 39 for glue, erected above and under the surface of the table 1 at the inlet 15 of the laminating device 3.

In order to form the support 2, the extruder press 32 is fed with for example granules 40 of thermoplastic polypropylene enriched with talc which is extruded to a synthetic foil 41, after which semi-hexagonal cells are formed in said synthetic foil 41 by means of the moulding press 33, which are connected to each other and which, during their passage in the folding installation 36, are folded together so as to form cells of a honeycomb structure which is led through the laminating device 38 to finally form a support 2 which, after the application of an extruded layer of glue 26 on the bottom and top side of the support 2, obtained from hot adhesive granules 43, is led through the laminating device 3 together with the coating layers 11-30 so as to form the required visual communication panels 25.

It is clear that the support 2 can be of any nature and make, whereby said support 2 is preferably made in a continuous manner, however, in a production line 31 preceding the laminating device 3.

Other possible materials for supports are for example chipboard, foamed polyurethane, synthetic material, corrugated board, honeycomb structures made of cardboard or the like.

In the case of a support made of foamed polyurethane, it is clear that the polyurethane itself forms an adhesive which adheres to the coating layers 11-28 when it cures, without an extra layer of glue having to be provided. In this case, it is for example possible to make use of a double-belt laminating machine to provide the continuously formed communication panel with the required thickness.

Although FIG. 4 represents two separate laminating devices 3 and 31, it is not excluded that only a single laminating device is applied which is used to laminate the support 2 itself, as well as to laminate the coating layers 11 and 28 on the support 2.

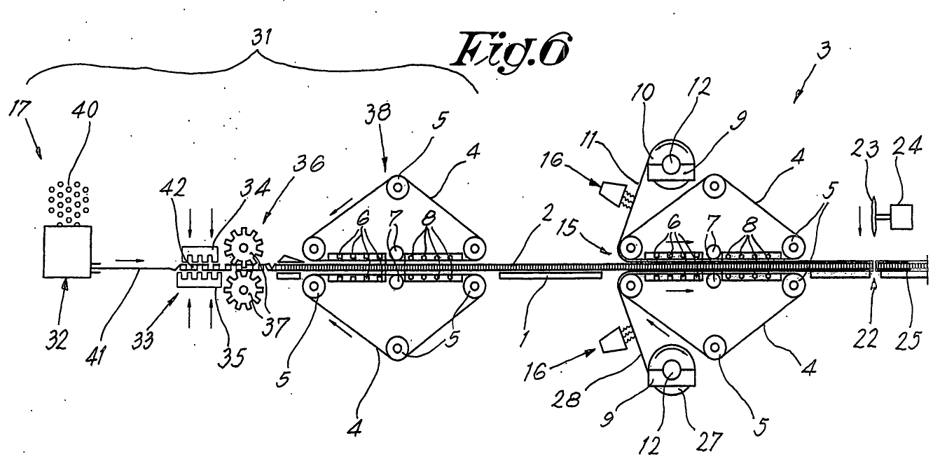

The device according to FIG. 5 differs from the device in FIG. 4 in that the means 17 for applying a layer of glue in this case consist of two applicators 44 which spread liquid or powdered glue 45 directly on the coating layers and/or on the support 2.

To this end, use can be made for example of various types of cold glue, what are called contact adhesives, which provide for a bond thanks to the evaporation of organic solvents; of a water-based glue dispersion, such as for example polyvinyl acetate glue, which provides for a bond thanks to the evaporation of water; of a single-part or two-part liquid polyurethane adhesive (“1C or 2C PU adhesive”) or of an epoxy adhesive which provides for a bond as the liquid glue cures.

The layer of glue can also be formed of various types of hot glues, what are called hot-melt adhesives, which provide for a bond as the melted glue solidifies or congeals; of a polyurethane hot glue (“PU hotmelt”) which provides for a bond as a melted glue solidifies and cures; of industrially available reactive hot adhesive granules or powders, such as for example ethylene acrylic co-polymers, which provide for a bond by means of temperature and pressure.

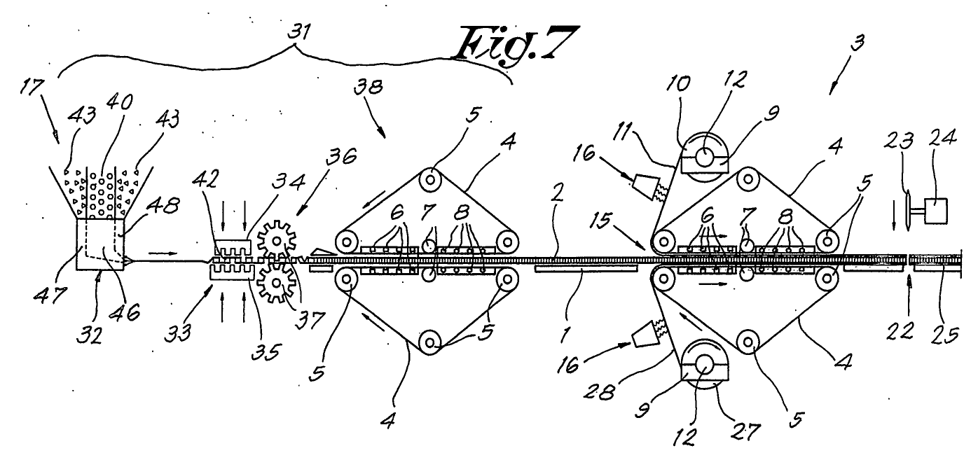

FIG. 6 represents another variant, whereby gluing components have already been integrated in the granules 40 for the extrusion of the synthetic foil 41 in this case, such that these components are found in the material of the support 2 itself and glue the honeycomb cells of the support 2 and of the coating layers 11-28 on the support 2 during their passage through the laminating devices 3-38.

Such gluing components can for example be obtained on the basis of an additive in the shape of a mixture of polypropylene or polyethylene with ethylene acrylic acid, maleic anhydride polypropylene or polyethylene vinyl acetate.

FIG. 7 represents a variant, whereby the extruder press 32 in this case comprises three compartments 46-47-48, one compartment 46 with granules 40 for extruding a synthetic foil 41 and two compartments 47-48 with hot adhesive granules 43 respectively, for example made of ethylene acrylic acid co-polymers (EAA), for extruding an adhesive film on either side of the above-mentioned synthetic foil 41.

The present invention is by no means limited to the above-described embodiments given as an example and represented in the accompanying drawings; on the contrary, such a method and device for manufacturing visual communication panels can be made in all sorts of variants while still remaining within the scope of the invention.

1. Method for manufacturing visual communication panels comprising a support, that is to be provided on at least one side with a coating made of enamelled metal glazed at temperatures above 500° C., comprising the steps: applying a continuous coating layer of enamelled metal on at least one side of a continuous support in the form of a plating; in gluing the coating layer on the support; in pressing the coating layer against the support to form a continuous panel with the required thickness; and finally, optionally, sawing the resulting continuous panel into individual panels having desired dimensions.

2. Method according to claim 1, wherein the continuous support is provided with a continuous coating layer on either side, and wherein at least one coating layer is formed of enamelled metal glazed at temperatures above 500° C.

3. Method according to claim 1, wherein for pressing on each coating layer the support is synchronously led through a laminating device together with each coating layer, and wherein each continuous coating layer is unwound from a roll.

4. Method according to claim 3, wherein each coating layer is heated before led into the laminating device.

5. Method according to claim 2, wherein between the support and each coating layer there is provided a layer of glue.

6. Method according to claim 5, wherein each layer of glue comprises a cold glue.

7. Method according to claim 5, wherein each layer of glue comprises a hot glue which melts under the influence of heat and congeals again when cooled.

8. Method according to claim 7, wherein the layer of glue is based on a hot glue in the form of a hot-melt adhesive.

9. Method according to claim 7, wherein the layer of glue comprises polymers in the form of hot-melt adhesive granules or powders.

10. Method according to claim 3, wherein the support and each coating layer is subsequently heated and cooled again.

11. Method according to claim 3, wherein each layer of glue is formed of an adhesive film wound on a roll and which is fed through the laminating device together with and between the support and each respective coating layer.

12. Method according to claim 11, wherein each layer of glue is provided on at least one of the support and each coating layer.

13. Method according to claim 5, wherein each layer of glue is obtained from adhesive granules which are extruded to form an adhesive film.

14. Method according to claim 5, wherein the process for obtaining each layer of glue is selected from the group consisting of: spraying, curtain coating, roller coating, silkscreen printing, stencilling and powdering.

15. Method according to claim 14, wherein the support, when being supplied, is already provided with a layer of glue, or in that the material of the supplied support comprises gluing components or has gluing properties.

16. Device for manufacturing visual communication panels according to the method of claim 3, a transport table providing a continuous support; at least one roll of a continuous coating layer which is formed of a continuous layer of enamelled metal; a laminating device through which the support and the coating layer are led; a gluing means for gluing the coating layer to the support; and optionally a sawing device downstream of the laminating device.

17. Device according to claim 16, including two rolls of a coating layer, of which at least one coating layer is formed of an enamelled metal, wherein the support is movable through the laminating device between the coating layers and wherein the glue applying means is arranged to apply a layer of glue between the support and both coating layers.

18. Device according to claim 16, including: one or more heating appliances which are provided opposite to the coating layer or layers.

19. Device according to claim 16, the laminating device is formed of a table and an endless belt opposite to said table, and of two endless belts erected opposite to one another, wherein the laminating device is provided with heating elements and with cooling elements.

20. Device according to claim 16, wherein glue applying means comprises one or two rolls with carrying an adhesive film, whereby wherein the or each adhesive film is lead through the laminating device between the support and a respective coating layer.

21. Device according to claim 16, wherein the glue applying means (17) is formed of at least one extruding application which is fed with adhesive granules.

22. Device according to claim 16, wherein the glue applying means comprises one or more appliances for applying glue selected from the group consisting of spraying, curtain coating, roller coating, silkscreen printing, stencilling and scattering glue.
